(19) United States
(12) Patent Application Publication
(10) Pub. No.: US 2006/0121753 A1
(43) Pub. Date: Jun. 8, 2006

(54) [BURN-IN SOCKET]

(75) Inventors: YUNG-LIANG CHIANG, TAIPEI (TW); Kuo-Feng Chen, (US)

Correspondence Address: SPEED MASTER TECHNOLOGY CO., LTD., P.O. BOX 108-00403, TAIPEI, TW

(73) Assignee: SPEED MASTER TECHNOLOGY CO., LTD, HSINTIEN CITY (TW)

(21) Appl. No.: 10/904,923

(22) Filed: Dec. 6, 2004

(51) Int. Cl. H01R 12/00

(52) U.S. Cl. 439/70

(57) ABSTRACT

A burn-in socket for burn-in test is disclosed to include a body holding a set of terminals, and a shell detachably fastened to the body with locating pins that are detachably mounted in respective mounting through holes in the shell and inserted into respective mounting holes in the body for holding a test sample (electronic element) in contact with the terminals.

### BACKGROUND OF THE INVENTION

1. Field of the Invention

The present invention relates to a burn-in socket for burn-in test and more particularly, to such a burn-in socket, which has a shell detachably fastened to the body thereof for holding the test sample to test. The user can replace the shell subject to the size of the sample to test.

2. Description of the Related Art

Following fast development of high technology, electronic devices are designed in the trend of light, think, short and small styles. After fabrication, electronic elements may have to receive burn-in test, examining their life cycle under an environment of high temperature, high voltage and high current. Inferior electronic elements that do not pass the test are swept out.

During burn-in test, a burn-in socket is used to hold the test sample and to electrically connect the test sample to a test apparatus for test. However, because different test samples (memory devices, logic products, sockets) have different contact pin patterns, different burn-in sockets shall be prepared for holding different test samples, thereby resulting in high test cost. The terminals of conventional burn-in sockets are made of resilient metal material or have a respective spring member fixedly connected thereto for positive connection to respective contacts at an adapter board that is used to connect the burn-in socket to a test apparatus. Therefore, changing a burn-in socket subject to the type of the test samples to test is complicated. Further, following the trend of micromization, nanotechnology has been employed to the fabrication of IC chips, and related burn-in sockets are micromized. When connecting the terminals of a micromized burn-in sockets to a test apparatus, the terminals may be deformed or inserted into wrong contact holes accidentally, and a short circuit may occur when turned on the test apparatus, thereby causing the test sample to be burned out.

### SUMMARY OF THE INVENTION

The present invention has been accomplished under the circumstances in view. According to one aspect of the present invention, the burn-in socket comprises a body holding a set of terminals, and a shell detachably fastened to the body with locating pins that are detachably mounted in respective mounting through holes in the shell and inserted into respective mounting holes in the body for holding a test sample (electronic element) in a receiving hole thereof in contact with the terminals. Therefore, the user can change the shell subject to the type of the test sample (electronic element) to test. According to another aspect of the present invention, a cover is pivotally coupled to the shell for closing the test sample (electronic element) in the receiving hole of the shell. The cover has a spring-supported hook provided at the free end for hooking on a part of the shell to hold the cover in the close position. According to another aspect of the present invention, an adapter board may be used with the burn-in socket to electrically connect the terminals to a test apparatus, preventing deformation of the terminals during installation of the burn-in socket in the test apparatus.

### BRIEF DESCRIPTION OF THE DRAWINGS

FIG. 1 is an exploded view of a burn-in socket according to the present invention.

FIG. 2 is an elevational view of the burn-in socket according to the present invention.

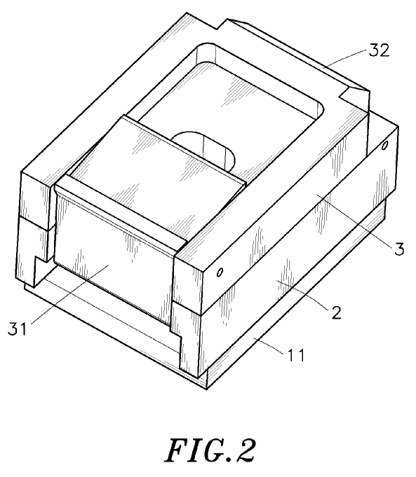

FIG. 3 is a side view in section of the burn-in socket according to the present invention.

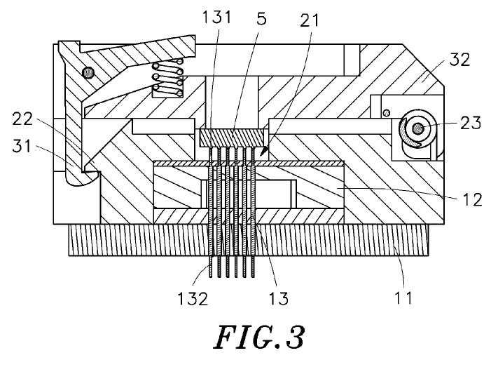

FIG. 4 is a schematic drawing of the present invention after removal of the cover from the shell, showing the positioning of a test sample in the burn-in socket.

FIG. 5 illustrates the burn-in socket used with an adapter board according to the present invention.

FIG. 6 is a sectional side view in an enlarged scale of FIG. 5.

### DETAILED DESCRIPTION OF THE PREFERRED EMBODIMENT

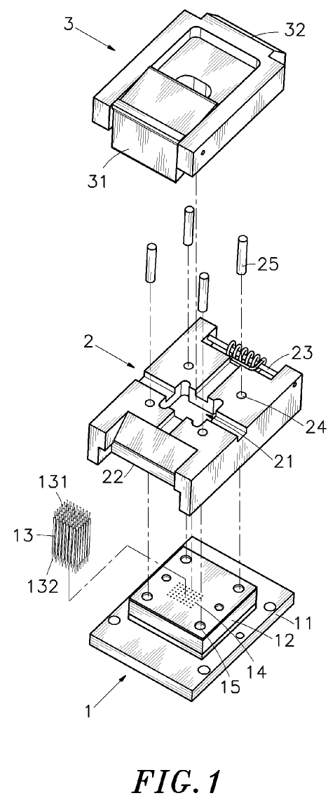

Referring to FIGS. 1˜3, a burn-in socket in accordance with the present invention is shown comprising a body 1, a shell 2, and a cover 3.

The body 1 comprises a base 11, a locating block 12 provided at the top of the base 11, a plurality of terminal slots 14 vertically extended through the locating block 12 and the base 11, and a plurality of mounting holes 15 formed in the locating block 12. Further a plurality of terminals 13 is respectively mounted in the terminal slots 14, each having a contact portion 131 at one end and a mounting portion 132 at the other end. The terminals 13 are preferably made of resilient metal material. Alternatively, the mounting portions 132 of the terminals 13 can be formed of metal spring members.

The shell 2 accommodates the body 1, comprising a receiving hole 21 adapted to receive a test sample (electronic element) 5, a fixed hook 22 provided at one side, a pivot axle 23 transversely provided at the other side opposite to the fixed hook 22, and a plurality of mounting through holes 24 respectively connected to the mounting holes 15 of the body 1 with locating pins 25.

The cover 3 comprises a knuckle 32 transversely provided at one end and pivotally coupled to the pivot axle 23 of the shell 2, and a spring-supported hook 31 pivotally provided at the other end remote from the knuckle 32 for hooking the fixed hook 22 of the shell 2. When closed the cover 3 on the body 2, the spring-supported hook 31 is hooked up with the fixed hook 22 of the shell 2 to hold the cover 3 in the close position. When disengaging the spring-supported hook 31 from the fixed hook 22 of the shell 2, the cover 3 can be tuned about the pivot axle 23 from the close position to an open position. After insertion of the test sample (electronic element) 5 into the receiving hole 21 of the shell 2, the cover 3 is closed to hold the test sample (electronic element) 5 in position, keeping the respective contacts of the test sample 5 in contact with the contact portions 131 of the terminals 13 for burn-in test.

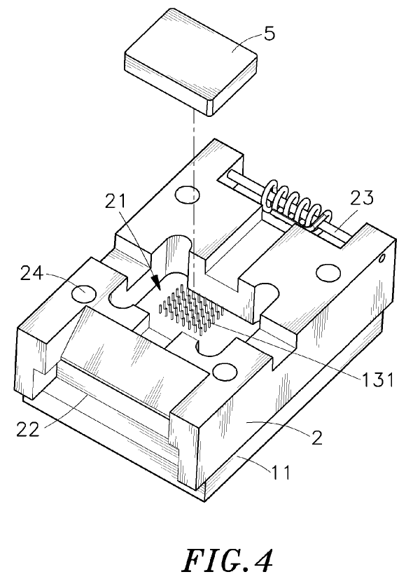

Referring to FIG. 4, the shell 2 is covered on the body 1 over the locating block 12, and the locating pins 25 are respectively mounted in the mounting through holes 24 of the shell 2 and the mounting holes 15 of the body 1 to secure the shell 2 to the body 1. The shell 2 can be detached from the body 1 for a replacement after removal of the locating pins 25 from the mounting through holes 24 of the shell 2 and the mounting holes 15 of the body 1. Therefore, a different shell 2 can be used with the body 1 to fit a different test sample (electronic element) 5.

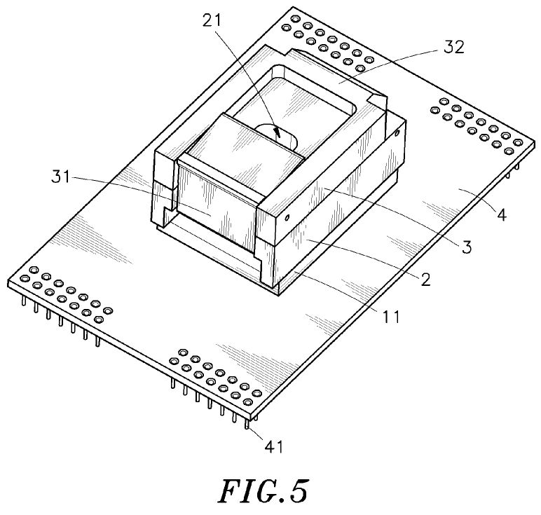

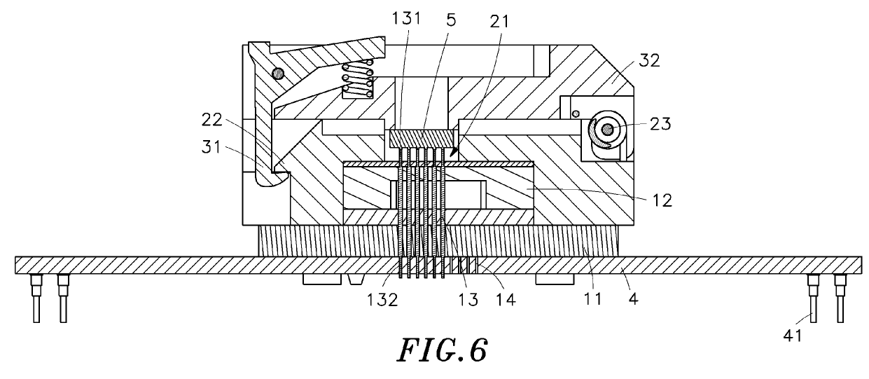

Referring to FIGS. 5 and 6, after installation of the terminals 13 in the terminal slots 14 of the body 1, the contact portions 131 and mounting portions 132 of the terminals 13 respectively protrude over the top side of the locating block 12 and the bottom side of the base 11. The mounting portions 132 of the terminals 13 can be fastened to respective contacts (contact holes) of an adapter board 4, which has a plurality of bottom contact pins 41 for connection to a test apparatus (not shown). By means of the adapter board 4, the terminals 13 connect the test sample (electronic element) 5 to the test apparatus for test. Because the terminals 13 are not inserted in and out of the test apparatus, connecting the burn-in socket to the test apparatus does not cause the terminals 13 to deform.

A prototype of burn-in socket has been constructed with the features of FIGS. 1˜6. The burn-in socket functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A burn-in socket comprising
a body, said body comprising a base, a locating block provided at a top side of said base and holding a plurality of terminals; and
a shell covered on said body, said shell comprising a receiving hole adapted to receive a test sample (electronic element) in contact with said terminals for test;
wherein said locating block of said body has a plurality of mounting holes; said shell has a plurality of mounting through holes and a plurality of locating pins respectively mounted in said mounting through holes and detachably inserted into the mounting holes of said locating block to detachably secure said shell to said body.

2. The burn-in socket as claimed in claim 1, wherein said shell further comprises a fixed hook provided at a first side thereof, a pivot axle transversely provided at a second side thereof opposite to said first side, and a cover for covering said receiving hole, said cover comprising knuckle means transversely provided at a first end thereof and pivotally coupled to said pivot axle and a spring-supported hook pivotally provided at a second end thereof for hooking said fixed hook of said shell.

3. The burn-in socket as claimed in claim 1, wherein said body comprises a plurality of terminal slots vertically extended through said locating block and said base, said terminals are respectively mounted in said terminal slots, each said terminal having a contact portion protruded over a top side of said locating block for the contact of a test sample (electronic element) and a mounting portion protruded over a bottom side of said base for connection to a test apparatus.

4. The burn-in socket as claimed in claim 1, wherein said terminals are respectively made of resilient metal material.

5. The burn-in socket as claimed in claim 3, wherein said mounting portion of each said terminal is formed of a metal spring member.
